(19) United States
(12) Patent Application Publication
(10) Pub. No.: US 2022/0279123 A1
(43) Pub. Date: Sep. 1, 2022

(54) NON-CONTACT VIBRATION DETECTION SYSTEM AND METHOD

(71) Applicants: Xing Li, Cupertino, CA (US); Shujuan Yuan, San Jose, CA (US)

(72) Inventors: Xing Li, Cupertino, CA (US); Shujuan Yuan, San Jose, CA (US)

(21) Appl. No.: 17/681,772

(22) Filed: Feb. 26, 2022

Related U.S. Application Data
(60) Provisional application No. 63/154,208, filed on Feb. 26, 2021.

(51) Int. Cl. H04N 5/232; G06T 7/11; G06T 7/00; G06T 7/80; G06V 10/25

(52) U.S. Cl. CPC H04N 5/23254; G06T 7/11; G06T 7/97; G06T 7/80; G06V 10/25; G06T 2200/24; G06T 2207/20221

(57) ABSTRACT

A portable computer-vision-based non-contact vibration detection system and method. The system can process small vibrations and large vibrations separately in the captured images. The small vibrations can be enhanced, and the enhanced small vibrations are analyzed, and the analysis results of the small vibrations and large vibrations are fused, and the processed images are displayed through a GUI. The analysis results include displacements in Region of Interest, vibration frequencies or cycles, vibration amplitudes and phase angles, root mean square (RMS) values, etc., along with overall ‘virtual’ snapshots of vibrations with maximum amplitudes during the working period of the camera.

### CROSS-REFERENCE TO RELATED APPLICATIONS

This application claims priority from the U.S. provisional patent application Ser. No. 63/154,208, filed on Feb. 26, 2021, which is incorporated herein by reference in its entirety.

### FIELD OF INVENTION

The present invention relates to a system and method for detecting vibration, and more particularly, the present invention relates to a non-contact vibration detection system and method.

### BACKGROUND

Machines, engineering structures, motors, engines, high voltage lines, and the like structures are exposed to various kinds of stress in normal and abnormal working states. Such stresses can induce damage and may result in failure of the structure over time. Monitoring of such stresses and timely detection of the defects can allow taking right precautionary steps for preventing further damage and failures.

Contact sensors, such as accelerometers are widely used in monitoring systems to obtain vibration information for analysis. Conventional contact sensors are popular; however, they present a variety of limitations. The primary limitation is the essential contact with the target structure to obtain the vibration information. Often, it may not be desired to contact the target structure to detect vibrations in the target structure, or the installation of the contact sensors may not be possible. Another limitation is the lack of representation of the vibrations, but only the vibration signals can be obtained from the contact sensors.

Non-contact vibration detection tools are also known in the art including hologram interferometry, speckle photography, and laser Doppler vibrometer. However, the use of such tools is too complex and costly for practical applications.

Camera-based vibration detection systems have also been recently introduced as an alternative for contact sensors and non-contact vibration detection tools. However, the technology is still evolving, and the current technology lacks accurate vibration measurements. Also, with current camera-based vibration detection technology, only projections of vibration which are parallel to the image planes can be obtained. Recently, video-based motion magnification techniques, including Eulerian approaches and phase-based approaches were introduced that can also enhance small movements in display but have disadvantages similar to those camera-based vibration detection techniques.

Thus, there currently exists an industry need for a novel device for precise detection and representation of the vibrations in a target object, thereby eliminating the need for contact with the target object while. All of the foregoing is accomplished with the present invention while being cost effective and easy to use.

### SUMMARY OF THE INVENTION

The following presents a simplified summary of one or more embodiments of the present invention in order to provide a basic understanding of such embodiments. This summary is not an extensive overview of all contemplated embodiments and is intended to neither identify key or critical elements of all embodiments nor delineate the scope of any or all embodiments. Its sole purpose is to present some concepts of one or more embodiments in a simplified form as a prelude to the more detailed description that is presented later.

The principal object of the present invention is therefore directed to a system and method for precise detection of vibration.

It is another object of the present invention that the system is compact and portable.

It is still another object of the present invention that the system and method are economical to manufacture and operate.

It is yet another object of the present invention that the system and method are easy to use.

In one aspect, disclosed is a system for vibration detection in an object, the system comprising a housing; a camera enclosed in the housing, the camera configured to capture a set of images of the object; a processing unit enclosed in the housing and operably coupled to the camera, the processing unit configured to receive the set of images from the camera; recognize regions of vibrations in the set of images; apply vibration region segmentation algorithm to the regions of vibrations to segment them in small vibration and large vibration based on predefined rules; apply a small vibration enhancement algorithm to the small vibration to enhance them; analyze, using vibration analysis algorithms, the enhanced small vibration to obtain a small vibration analysis and the large vibration to obtain a large vibration analysis; and apply an image fusion algorithm to fuse the small vibration analysis and the large vibration analysis obtaining a set of processed images having a virtual magnification of the small vibration.

In one implementation of the system, the processing unit is further configured to receive a selection of regions of interests, wherein the regions of vibrations are recognized in the regions of interests. The system further comprises a display encased by the housing, wherein the processing unit is further configured to implement a graphical user interface (GUI) presented on the display, display the set of processed images through an image display zone and vibration result display zone, wherein the image display zone and the vibration result display zone are implemented through the GUI. The system further comprises a touch input coupled to the display, the GUI configured to receive inputs through the touch input. The system further comprises a fastening member coupled to the housing, wherein the fastening member is configured to mount the system to a tripod stand. The system further comprises rechargeable batteries enclosed in the housing for powering the system. The processing unit is further configured to receive a calibration for the camera, wherein the calibration comprises lens distortion and pixel size calibration. The system further comprises one or more lenses; a lens housing configured to interchangeably receive a lens of the one or more lenses, wherein the processing unit is configured to receive a parameter through a parameter control panel implemented by the GUI, wherein the parameter is for a focal length. Each of the small vibration analysis and the large vibration analysis comprises displacements of the region of interests, vibration frequencies or cycles, vibration amplitudes and phase angles, and root mean square (RMS) values.

In one aspect, disclosed is a method for detecting and representing vibration in an object, the method implemented within a system comprising a housing; a camera enclosed in the housing, the camera configured to capture a set of images of the object; and a processing unit enclosed in the housing and operably coupled to the camera. The method comprises the steps of receiving, by the processing unit, the set of images from the camera; recognizing regions of vibrations in the set of images; applying a vibration region segmentation algorithm to the regions of vibrations to segment them in small vibration and large vibration based on predefined rules; applying a small vibration enhancement algorithm to the small vibration to enhance them; analyzing, using vibration analysis algorithms, the enhanced small vibration to obtain a small vibration analysis and the large vibration to obtain a large vibration analysis; and applying an image fusion algorithm to fuse the small vibration analysis and the large vibration analysis obtaining a set of processed images having a virtual magnification of the small vibration.

In one implementation of the method, the method further comprises the steps of identifying regions of interests, wherein the regions of vibrations are recognized in the regions of interests. The system further comprises a display encased by the housing, wherein method further comprises the steps of implementing a graphical user interface (GUI) presented on the display, displaying the set of processed images through an image display zone and vibration result display zone, wherein the image display zone and the vibration result display zone are implemented through the GUI. The system further comprises a touch input coupled to the display, the GUI configured to receive inputs through the touch input. The system further comprises a fastening member coupled to the housing, wherein the fastening member is configured to mount the system to a tripod stand. The system further comprises rechargeable batteries enclosed in the housing for powering the system. The method further comprises the steps of receiving a calibration for the camera, wherein the calibration comprises lens distortion and pixel size calibration. The system further comprises one or more lenses; a lens housing configured to interchangeably receive a lens of the one or more lenses, wherein the method further comprises the steps of: receiving a parameter through a parameter control panel implemented by the GUI, wherein the parameter is for a focal length.

### BRIEF DESCRIPTION OF THE DRAWINGS

The accompanying figures, which are incorporated herein, form part of the specification and illustrate embodiments of the present invention. Together with the description, the figures further explain the principles of the present invention and to enable a person skilled in the relevant arts to make and use the invention.

FIG. 1 is a perspective view of the system for detecting and representing vibration, according to an exemplary embodiment of the present invention.

FIG. 2 is a block diagram of the system, according to an exemplary embodiment of the present invention.

FIG. 3 shows a graphical user interface, according to an exemplary embodiment of the present invention.

FIG. 4 is a flow chart illustrating the method of detecting vibration, according to an exemplary embodiment of the present invention.

### DETAILED DESCRIPTION

Subject matter will now be described more fully hereinafter with reference to the accompanying drawings, which form a part hereof, and which show, by way of illustration, specific exemplary embodiments. Subject matter may, however, be embodied in a variety of different forms and, therefore, covered or claimed subject matter is intended to be construed as not being limited to any exemplary embodiments set forth herein; exemplary embodiments are provided merely to be illustrative. Likewise, a reasonably broad scope for claimed or covered subject matter is intended. Among other things, for example, the subject matter may be embodied as methods, devices, components, or systems. The following detailed description is, therefore, not intended to be taken in a limiting sense.

The word “exemplary” is used herein to mean “serving as an example, instance, or illustration.” Any embodiment described herein as “exemplary” is not necessarily to be construed as preferred or advantageous over other embodiments. Likewise, the term “embodiments of the present invention” does not require that all embodiments of the invention include the discussed feature, advantage or mode of operation.

The terminology used herein is for the purpose of describing particular embodiments only and is not intended to be limiting of embodiments of the invention. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

The following detailed description includes the best currently contemplated mode or modes of carrying out exemplary embodiments of the invention. The description is not to be taken in a limiting sense but is made merely for the purpose of illustrating the general principles of the invention, since the scope of the invention will be best defined by the allowed claims of any resulting patent.

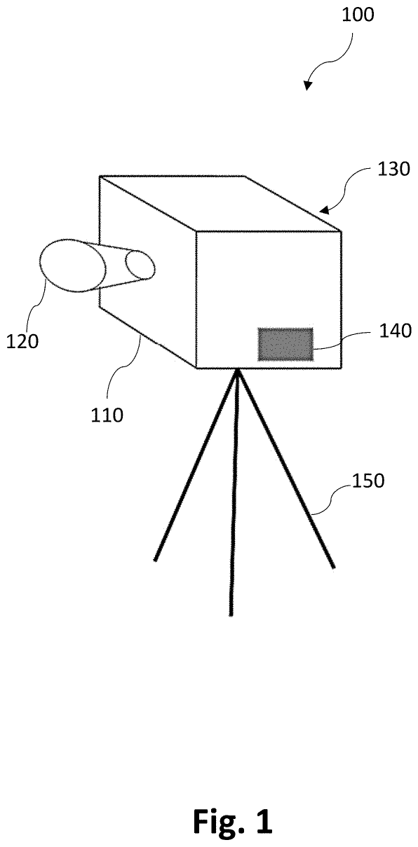

Disclosed are the system and method for detecting and visually representing vibration in engineering structures, such as but not limited to bridges, motors, buildings, machines, and the like. The disclosed system can be used for bridge inspection, cable force measurements in cable staged bridges, motor/engine inspection, high-voltage line inspection, and like engineering processes. The disclosed system can be compact and portable that can be mounted to a tripod for operation. Referring to FIG. 1 which shows an exemplary embodiment of the disclosed system 100 mounted to a tripod 150. The system 100 can include a housing 110 that encases the components, including a camera unit, processing unit, batteries, and a display. The bottom of the housing can include a fastening member for mounting the disclosed system to a tripod. The tripod and such fastening members are well known, and any such known fastening member can be incorporated without departing from the scope of the present invention. Suitable dampeners that can reduce vibration and stabilize the system can also be incorporated into the tripod. The tripod can include functionalities for rotating the system 100 which is also well known. A lens 120 can be seen protruding from the front of the housing 110 and can be coupled to a camera unit encased within the housing 110. A display 130 can be provided on the rear of the housing 110 i.e., opposite to the lens 120. The control interface 140 on the right of the housing can include suitable control buttons for operating the disclosed system. Preferably, a touch input can be incorporated in the display for receiving input from a user. A “user” as used herein, and throughout this disclosure, refers to an individual directly or indirectly using the disclosed system for vibration detection.

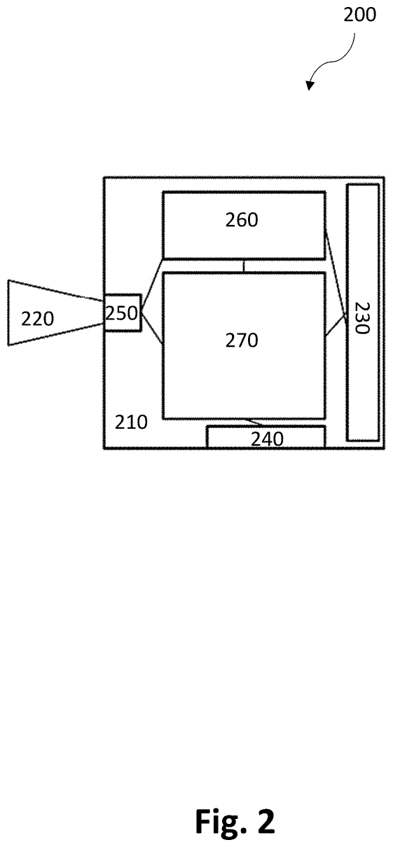

Referring to FIG. 2 which is a block diagram of the disclosed system 200 showing the housing 210, a camera lens 220, a camera 250, a display 230, a battery 260, an interface 240, and a processing unit 270. The camera lens 220 can be interchangeably coupled to the camera through a lens housing/connector. Different camera lenses with different focal lengths can be provided that can be interchangeably used according to the target object of which the vibration has to be detected and the requirements of vibration detection. The camera can be coupled to the processing unit. The processing unit can include a set of modules which upon execution by a processor allows a user to operate the disclosed system and to implement in near real-time image processing and vibration analysis by utilizing a customized graphical user interface (GUI). The GUI can be presented on the display. The display can include touch input functionality that allows a user to interact with the disclosed system and provide his input. The technologies behind the display and touch input are well known and not discussed further herein. A user can focus on a target, capture images, adjust, or tweak the setting using the GUI. Soft buttons can be implemented through the GUI wherein the user can click the soft button through a finger or stylus to navigate through different menus and settings. It is understood, however, that the touch input is only one mode of input, any other input mode is within the scope of the present invention. Moreover, it is also envisioned that predefined profiles that include different settings suitable for different situations can also be provided, wherein a user rather than navigating through a range of settings can choose a specific profile based on the target and scene. The profiles can be provided with a descriptive name that may allow selection of the profile according to the scene and target object easier. Also, it is within the scope of the present invention that the user can modify any existing profile, restore any profile, as well as create new profiles. The processing unit can receive the captured images data in real-time for further processing and storage. Moreover, the captured images can be presented on the display for review by the user as and when desired. The real-time captured images can also be shown in real-time on the display through the GUI.

The system can be powered by batteries which can also be enclosed within the housing. The batteries can be replaceable or rechargeable, and any known battery technology can be incorporated without departing from the scope of the present invention. For example, Lithium rechargeable batteries are widely used in electronics and can be used to power the disclosed system. In case, rechargeable batteries are used, suitable charging circuitry can also be embodied. The charging circuitry can be external to the system or encased within the housing of the system. Additionally, an external power source can also be used to power the disclosed system, such as an AC/DC adaptor, and suitable circuitry for connecting to the external power supply can also be embodied.

The processing unit can include central processing units (CPUs), field-programmable gate array (FPGA), or other embedded computing boards with GPU-based micro-Al chips. Suitable memory chips can also be included for an operating system and modules according to the present invention. The module herein and used throughout this disclosure refers to a set of instructions or software which upon execution by the processor performs one or more steps of the disclosed methodology. The memory can include an interface module, a hardware control module, and an image processing and vibration analysis module. The hardware control module can implement the methods for camera control, calibration, and image collection; network control and data transmission; and CPUs/GPUs/AI chips control and settings. The image processing and vibration analysis module can implement the methods of image pre-processing, image enhancement, vibration information extraction, vibration analysis, and image fusion. The interface module can implement the method for image display, parameter settings, user interaction, result display, report writer, and display.

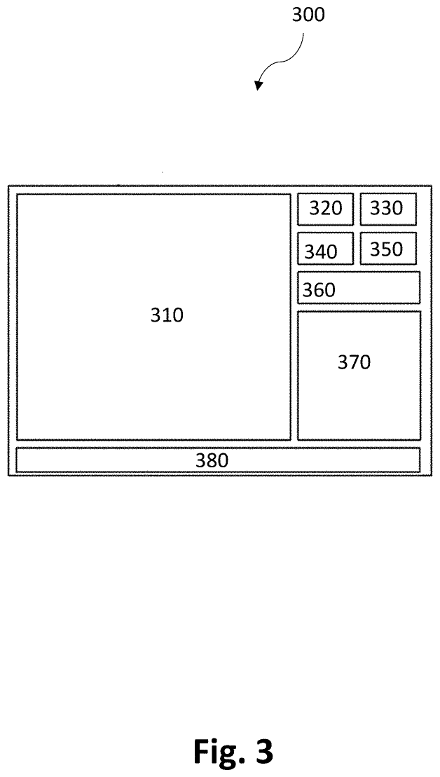

Referring to FIG. 3 which shows an implementation of the GUI by the disclosed system 200 and presented on the display 230. The GUI 300 can include an image display zone 310, capture control panel 320, video processing panel 330, vibration analysis panel 340, parameter configure panel 350, vibration result display control panel 360, vibration result display zone 370, and an image frame replay control panel 380.

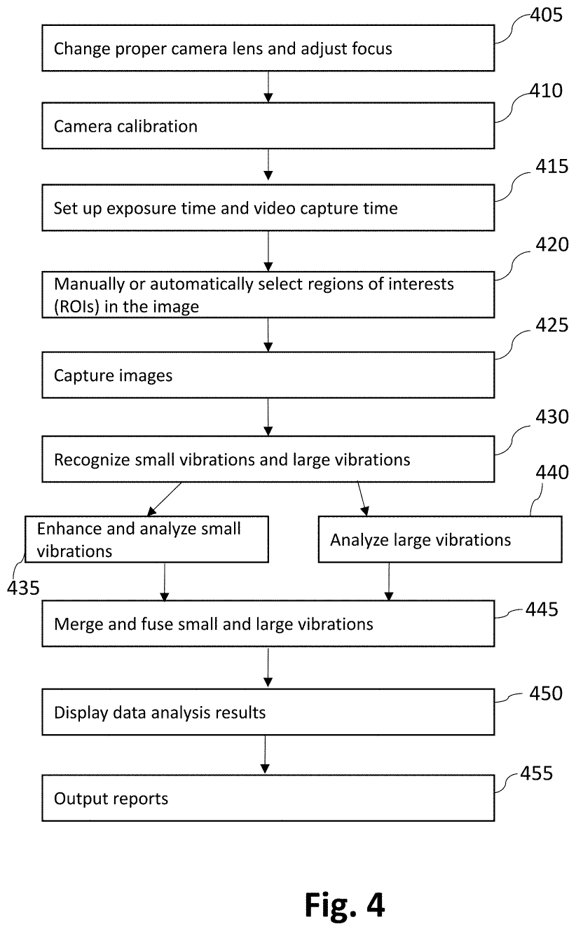

Referring to FIG. 4 which is a flow chart showing an exemplary embodiment of the present invention. At first, the user can select the proper camera lens based on the scene requirement and adjust the focus of the camera lens manually or automatically by the software to obtain clear images of the target, at step 405. The images can be shown on the display through the GUI in the display image zone 310 of the GUI as shown in FIG. 3. Next, the camera can be calibrated, including lens distortion and pixel size calibration, for accurate measurements, at step 410. The capture control panel 320 can provide different options for the user to calibrate the camera. The exposure time and video capture time can be set in the parameter configure panel 350, at step 415. Thereafter, the Regions of interest (ROIs) can be selected manually or automatically in the image display zone 310, at step 420. The user can manually select the regions of interest through the GUI's image display zone 310. The processing unit can select ROIs by implementing ROI selection algorithms. For example, the Harris Corner detector is a known corner detection operator that is commonly used in computer vision algorithms to extract corners and infer features of an image. An OpenCV function goodFeaturesToTrack( )can be used to implement the ROI selection. Once the ROI's can be indicated, the user can capture a series of images by using the capture control panel 320, at step 425. The captured images can be received by the processing unit for analysis and storage. The analysis can be done in near real-time or later, and the results of the analysis can also be saved. The processing unit can implement the vibration analysis methods to recognize vibration in the images, at step 430. The vibration can be segmented into small vibrations and large vibrations i.e., the vibrations of small amplitude and large amplitude. The small amplitude and large amplitude can be predefined in the disclosed system. The vibrations of amplitude in a range of 1 pixel to several pixels can be regarded as ‘small vibrations’ which are hardly seen by the eye. The vibrations whose amplitudes are larger than dozens of pixels can be regarded as ‘large vibrations’. The disclosed method has a choice to enhance the small vibrations to obtain virtual magnification of the vibrations for display. Only the small vibrations can be enhanced such that to minimize artifacts because of the vibration enhancement, which can be significant for large vibration enhancement. The processing unit can separately analyze the small vibration and the large vibration. The processing unit can enhance the small vibration and perform the analysis, at step 435. The processing unit can analyze the large vibrations at step 440.

In an exemplary embodiment, the processing unit can analyze the large vibration by implementing pattern matching or centroid-estimation algorithms based on the frame-wise analysis. The small vibrations can hardly be observed, image enhancement algorithm can be applied to enhance the vibration displacements in the frames. Thus, it is particularly advantageous before the vibration analysis to enhance the small vibrations. A suitable vibration region segmentation algorithm can be applied to separate the regions into two groups: the large vibration regions and the small vibration regions. The segmentation algorithm can use dense optical flow on the frame-wise analysis to compute the optical flow for all the points in the ROIs based on Gunner Farneback's algorithm. An OpenCV function calcOpticalFlowFarneback( )can be used to implement the dense optical flow calculation, then separate the ROI regions into two groups based on thresholding methods.

The processing unit can implement the small vibration enhancement algorithm based on a phase-based vibration enhancement technique to enhance the small vibrations in the ROIs frame by frame. For example, DTCWT (dual-tree complex wavelet transform) forward transform can decompose all the frame images into different level sub-images. Thereafter, can calculate the phase information of all level sub-images. Then, can calculate the differences of phase information among frames. Then, can enhance the differences by some factors and then add them into the phase information per frame. And then, DTCWT backward transform can regenerate the full-frame images.

The processing unit can implement the vibration analysis algorithms for analyzing the enhanced small vibrations. For each pixel in all frames, a time series curve can be generated. Fourier transform can be applied to this time series curve, and then the frequencies can be analyzed, the main periods or frequencies are obtained by peak seeking. On the other hand, the amplitudes of vibration can be obtained by analyzing the displacements in the X and Y directions.

After enhancement of small vibrations and analysis, the processing unit can merge and fuse the analysis results from both the small vibration and the large vibration into a series of processed images, at step 445. The processing unit can implement image fusion algorithms to fuse the enhanced small vibrations analysis with the large vibration analysis. The ROIs with enhanced vibrations can be fused into the original images. The linear/cubic interpolation methods can be used in the image fusion algorithm.

Steps 430 to 445 can be controlled on the video processing panel 330 and vibration analysis panel 340. The necessary parameters can be set up on the parameter configure panel 350. The processing unit can present the processed images and analysis results, through the GUI on the image display zone and the vibration result display zone, at step 450. The user can manipulate the images and analysis results by using the image frame replay control panel 380 and vibration result display control panel 360. Overall virtual snapshots of vibrations with maximum amplitudes during the working period of the camera can be made by the processing unit. The analysis results provided by the software and displayed include displacements of ROIs, vibration frequencies or cycles, vibration amplitudes, phase angles, root mean square (RMS) values, etc. The processed images and analysis results can be outputted as final reports, at step 455.

In certain embodiments, disclosed is a vibration analysis method that combines enhanced small vibration analysis and big vibration analysis. It provides accurate vibration measurements based on careful camera calibration. The method also provides an overall ‘virtual’ snapshot of vibrations with maximum amplitudes during the working period of the camera.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and examples, but by all embodiments and methods within the scope and spirit of the invention as claimed.

What is claimed is:

1. A system for vibration detection in an object, the system comprising:
a housing;
a camera enclosed in the housing, the camera configured to capture a set of images of the object;
a processing unit enclosed in the housing and operably coupled to the camera, the processing unit configured to:
receive the set of images from the camera;
recognize regions of vibrations in the set of images;
apply vibration region segmentation algorithm to the regions of vibrations to segment them in small vibration and large vibration based on predefined rules;
apply a small vibration enhancement algorithm to the small vibration to enhance them;
analyze, using vibration analysis algorithms, the enhanced small vibration to obtain a small vibration analysis and the large vibration to obtain a large vibration analysis; and
apply an image fusion algorithm to fuse the small vibration analysis and the large vibration analysis obtaining a set of processed images having a virtual magnification of the small vibration.

2. The system according to claim 1, wherein the processing unit is further configured to:
receive a selection of regions of interests, wherein the regions of vibrations are recognized in the regions of interests.

3. The system according to claim 1, wherein the system further comprises:
a display encased by the housing, wherein the processing unit is further configured to:
implement a graphical user interface (GUI) presented on the display,
display the set of processed images through an image display zone and vibration result display zone, wherein the image display zone and the vibration result display zone are implemented through the GUI.

4. The system according to claim 3, wherein the system further comprises a touch input coupled to the display, the GUI configured to receive inputs through the touch input.

5. The system according to claim 1, wherein the system further comprises a fastening member coupled to the housing, wherein the fastening member is configured to mount the system to a tripod stand.

6. The system according to claim 1, wherein the system further comprises rechargeable batteries enclosed in the housing for powering the system.

7. The system according to claim 1, wherein the processing unit is further configured to:
receive a calibration for the camera, wherein the calibration comprises lens distortion and pixel size calibration.

8. The system according to claim 3, wherein the system further comprises:
one or more lenses; and
a lens housing configured to interchangeably receive a lens of the one or more lenses, wherein the processing unit is configured to:
receive a parameter through a parameter control panel implemented by the GUI, wherein the parameter is for a focal length.

9. The system according to claim 2, wherein each of the small vibration analysis and the large vibration analysis comprises displacements of the region of interests, vibration frequencies or cycles, vibration amplitudes and phase angles, and root mean square (RMS) values.

10. A method for detecting and representing vibration in an object, the method implemented within a system comprising:
a housing;
a camera enclosed in the housing, the camera configured to capture a set of images of the object; and
a processing unit enclosed in the housing and operably coupled to the camera, wherein the method comprises the steps of:
receiving, by the processing unit, the set of images from the camera;
recognizing regions of vibrations in the set of images;
applying a vibration region segmentation algorithm to the regions of vibrations to segment them in small vibration and large vibration based on predefined rules;
applying a small vibration enhancement algorithm to the small vibration to enhance them;
analyzing, using vibration analysis algorithms, the enhanced small vibration to obtain a small vibration analysis and the large vibration to obtain a large vibration analysis; and
applying an image fusion algorithm to fuse the small vibration analysis and the large vibration analysis obtaining a set of processed images having a virtual magnification of the small vibration.

11. The method according to claim 10, wherein the method further comprises the steps of:
identifying regions of interests, wherein the regions of vibrations are recognized in the regions of interests.

12. The method according to claim 10, wherein the system further comprises:
a display encased by the housing, wherein the method further comprises the steps of:
implementing a graphical user interface (GUI) presented on the display,
displaying the set of processed images through an image display zone and vibration result display zone, wherein the image display zone and the vibration result display zone are implemented through the GUI.

13. The method according to claim 12, wherein the system further comprises a touch input coupled to the display, the GUI configured to receive inputs through the touch input.

14. The method according to claim 10, wherein the system further comprises a fastening member coupled to the housing, wherein the fastening member is configured to mount the system to a tripod stand.

15. The method according to claim 10, wherein the system further comprises rechargeable batteries enclosed in the housing for powering the system.

16. The method according to claim 10, wherein the method further comprises the steps of:
receiving a calibration for the camera, wherein the calibration comprises lens distortion and pixel size calibration.

17. The method according to claim 12, wherein the system further comprises:
one or more lenses; and
a lens housing configured to interchangeably receive a lens of the one or more lenses, wherein the method further comprises the steps of:
receiving a parameter through a parameter control panel implemented by the GUI, wherein the parameter is for a focal length.

18. The method according to claim 11, wherein each of the small vibration analysis and the large vibration analysis comprises displacements of the region of interests, vibration frequencies or cycles, vibration amplitudes and phase angles, and root mean square (RMS) values.
